(19) United States
(12) Patent Application Publication
(10) Pub. No.: US 2005/0079941 A1
(43) Pub. Date: Apr. 14, 2005

(54) Pinless conveyor chain or drive chain

(75) Inventor: Jose Perez, Vancouver (CA)

Correspondence Address: OYEN, WIGGS, GREEN & MUTALA;480 - THE STATION, 601 WEST CORDOVA STREET, VANCOUVER, BC, V6B 1G1, CA

(73) Assignee: NEWCHAIN HOLDINGS LTD., Vancouver (CA)

(21) Appl. No.: 10/952,870

(22) Filed: Sep. 30, 2004

(30) Foreign Application Priority Data
Oct. 9, 2003 (CA) 2444939

(51) Int. Cl. F16G 13/02

(52) U.S. Cl. 474/226; 474/230; 474/227

(57) ABSTRACT

This invention relates to a novel pinless conveyor chain or drive chain and a method of constructing and assembling such chains. These chains are used with sprockets, either to move materials in conveyors (conveyor chains) or to relocate the axial center or change the speed of rotation of axles (drive chains). A chain link comprising: (a) a barrel with side bar retaining members thereon; (b) a pair of first side bar half-sections with barrel gripping members at each end; (c) a pair of second side bar half-sections with barrel gripping members at each end; and (d) a pair of retaining members which respectively hold the first and second side bar half-sections together when the barrel gripping members hold the barrel.

### TECHNICAL FIELD

This invention relates to a novel pinless conveyor chain or drive chain and a method of constructing and assembling such chains. These chains are used with sprockets, either to move materials in conveyors (conveyor chains) or to relocate the axial center or change the speed of rotation of axles (drive chains).

### BACKGROUND

Chains and sprockets are widely used in industry in two basic applications. One is for the connection of two axles in machinery by a continuous chain which loops the two axles. The axles each have sprockets in the same plane, thereby transferring the rotational force of one axle (torque) to the other axle. A second application is to move materials in conveyors. In this application, the chain is in a continuous loop which is driven by one sprocket to which torque is applied by a motor or other means. An idler sprocket is located at the opposite end of the loop. One side of the loop may ride in a channel. The chain has plates, buckets, or similar attachments affixed at regularly spaced intervals which carry the materials in the direction of the chain movement.

Chains are usually made by joining individually manufactured links in various designs, but the links are commonly in a “U” shape with side bars affixed at each end of a tube (commonly called a barrel or roller). The open ends of the side bars are affixed to the next link by means of a pin which passes first through a hole at the end of one side bar, then through the tube of the next link, and then through the hole at the end of the other side bar. The pins are held in place by various known means, but commonly by a head at one end of the pin, and by riveting or a cotter pin at the other end of the pin. The teeth of the sprockets contact the center area of the tube portion of each link.

Due to the necessity for a tight fit, and the difficulty of chain assembly on job sites, the links, except for one pin, are usually assembled into chain lengths at a factory, and then when the chain is installed at the site, the final pin is affixed.

Chains are subjected to strong horizontal forces resulting in either breakage, or “elongation” of the chain. This “elongation” results from wear of the barrels, pins or holes in the side bars through which they pass.

In the event of chain failure, one pin must be removed in order to remove and replace the chain. If the pins are riveted, this is often not an easy task, especially in hostile environments. The chains can be very heavy to move and replace. Assembled chains of industrial size are heavy to move and ship, and do not roll up very compactly for storage or shipping.

A number of patents have been issued over the years for various designs of chains.

U.S. Pat. No. 6,220,011 B1, Dalferth et al., issued Apr. 24, 2001, discloses a connecting chain link for link chains having two connecting-link parts which can be displaced by limited amounts in the longitudinal direction of the connecting link, in order to open and close the connecting link, and which are each provided with a stub at one end and at the other end with a pocket to hold the stub, in the closed position the connecting-link parts are locked in place with the aid of a central locking element which rests in shell-shaped supporting surfaces of two projections which protrude into the clear interior of the connecting link.

U.S. Pat. No. 4,181,035, Shockley, issued Jan. 1, 1980, discloses an improved connecting link for a mining chain includes two half links and means for fastening them together. Each half link has a laterally extending bore for receiving the link pin at one end of the chain. At least one of the half links has a laterally extending wedge-shaped projection pointed toward the other half link, while the other half link has a mating recess with inclined walls corresponding to converging walls of the wedge-shaped projection. When assembled, the projection of the one half link snugly engages the recess of the other half link such that the pulling forces in the chain are transmitted directly from one half link to the other rather than through the fastening means. The fastening means can be removed even when the chain is operated between adjacent chains.

U.S. Pat. No. 4,150,583, Onulak, issued Apr. 24, 1979, discloses an improved chain link comprised of a two piece barrel, a pin and a sprocket engaging aperture. The chain link of the invention is formed from a blank having a body portion with a tongue attached to one end thereof. The tongue is formed into a barrel hook. A flap is taken from the inside of the body portion and formed toward the barrel hook to form the remainder of the barrel and the sprocket engaging aperture of the chain link. The pin is formed from the other end of the body portion.

U.S. Pat. No. 3,877,688, McCarty, issued Apr. 15, 1975, discloses a spring clip for maintaining sprocket or roller chain elements in assembled relationship. The clip is a resilient member having an arched center portion when viewed in elevation and spaced openings when viewed in plan. Pressure applied to the arched center portion flattens the member, so that the openings encircle an adjacent pair of link pins. Release of the pressure permits the clip to return to substantially original shape, so that the openings resiliently engage the pins, retaining the chain parts in assembled relationship.

U.S. Pat. No. 4,543,081, van Rooij et al., issued Sep. 24, 1985, discloses a transmission chain comprising links and hinge pins extending through link apertures an intermediate member being received between each hinge pin and the opposite aperture sides of a plurality of adjacent links, the length of the intermediate member being equal to or somewhat less than the length of the hinge pin a limited displacement thereof in the longitudinal direction being possible.

EP 1 234 999 A1, Okabe et al., published Aug. 28, 2002, provides a silent chain that can restrict abrasion of connection pins and the bushings and can restrict the abrasive elongation of chain so as to be especially used for a diesel engine. A circularity of bushings used in the link assembly thereof is easily maintained. The silent chain includes a guide plate, a link assembly having an inner link plate, a middle link plate, and a connection pin that connects them freely bendably. The bushings of the link assembly have no seam being made as solid type, and a plurality of concave areas for reserving oil are formed on surfaces of both end portions thereof. The notched concave areas have a depth that does not reach the inner link plate fixed to the bushing.

In order to solve some of the weight and assembly problems inherent with commonly used metal chains, non-metallic materials (plastics) have been used recently in an effort to reduce weight and to make assembly of the links easier. However, these non-metallic chains are not entirely trouble-free. Plastic, nylon or acetyl materials possess lower ultimate strength than steel or other metallic chains and thus can only handle lower working loads. Non-metallic chains are also subject to brittle fractures in cold conditions. Non-metallic chains with plastic or nylon pins, or non-metallic pins with steel cores do not perform well in shock, overload or misalignment situations. Thermal expansion and contraction occurs in some applications, causing separation of the steel cored pins and the non-metallic coating. Disposal of non-metallic chains is also an environmental problem when the chain reaches the end of its useful life due to leached toxins in landfills from the non-metallic material.

### SUMMARY OF INVENTION

The invention is directed to a chain link comprising: (a) a barrel with side bar retaining members thereon; (b) a pair of first side bar half-sections with barrel gripping members at each end; (c) a pair of second side bar half-sections with barrel gripping members at each end; and (d) a pair of retaining members which respectively hold the first and second side bar half-sections together when the barrel gripping members hold the barrel.

The barrel can be a solid or hollow cylinder. The cylinder can have radially extending shoulders at each end. The barrel gripping members can be in the form of semicircles. The first and second side bar half-sections can be placed together, with the semicircles at each end forming whole circles. Two or more retaining members, such as clamps, can be used for each pair of side bar half-sections.

The invention is also directed to a chain link comprising: (a) a barrel with at least two shoulders on the outside circumference thereof; (b) four side bar half-sections with a semicircle formed at each end, wherein each two side bar half-sections form a whole side bar which connects to the barrel by placing the semicircles of the side bar half-sections around the barrel within two shoulders of the barrel so that two semicircles form a circle which encircles the barrel; (c) a removable clamp affixed to each pair of side bar half-sections to hold the two side bar half-sections together.

Free ends of two semicircles of a pair of side bar half-sections can touch each other when the two semicircles encircle the barrel. The barrel can have three spaced parallel shoulders at one end and three spaced parallel shoulders at the other end.

The side bar half-sections can be formed of metal. The barrel can be formed of plastic or of metal and plastic. The barrel can be solid or hollow.

### BRIEF DESCRIPTION OF DRAWINGS

In drawings which illustrate specific embodiments of the invention, but which should not be construed as restricting the spirit or scope of the invention in any way:

FIG. 1 illustrates an elevation view of a half-section of a side bar.

FIG. 2 illustrates an elevation view of two side bar half-sections clamped together to form one complete side bar;

FIG. 3 illustrates an elevation view of a barrel.

FIG. 4 illustrates an elevation view of a portion of a chain assembled from transverse barrels and pairs of clamped side bar half-sections.

### DESCRIPTION

Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive, sense.

The invention is directed particularly to chain links made of five basic pieces plus two or more small clamps. These pieces comprise a barrel section which can be, but need not be hollow, with shoulders formed on the circumference thereof, and four similar half-section pieces of which each pair form one side bar split along the center in the direction of chain pull. One or more clamps hold the two half-section pieces of each side bar together. The first link is assembled by joining two parallel barrels by placing a parallel pair of side bar half-section pieces over the barrels at each end of the barrels and between the shoulders. The side bar half-section pieces are held together by forcing a clamp over each pair midway between the two barrels. The chain is assembled link by link in a similar manner. The assembled side bars are offset from the side bars of adjacent links where they are affixed to a common barrel (alternate inside link/outside link).

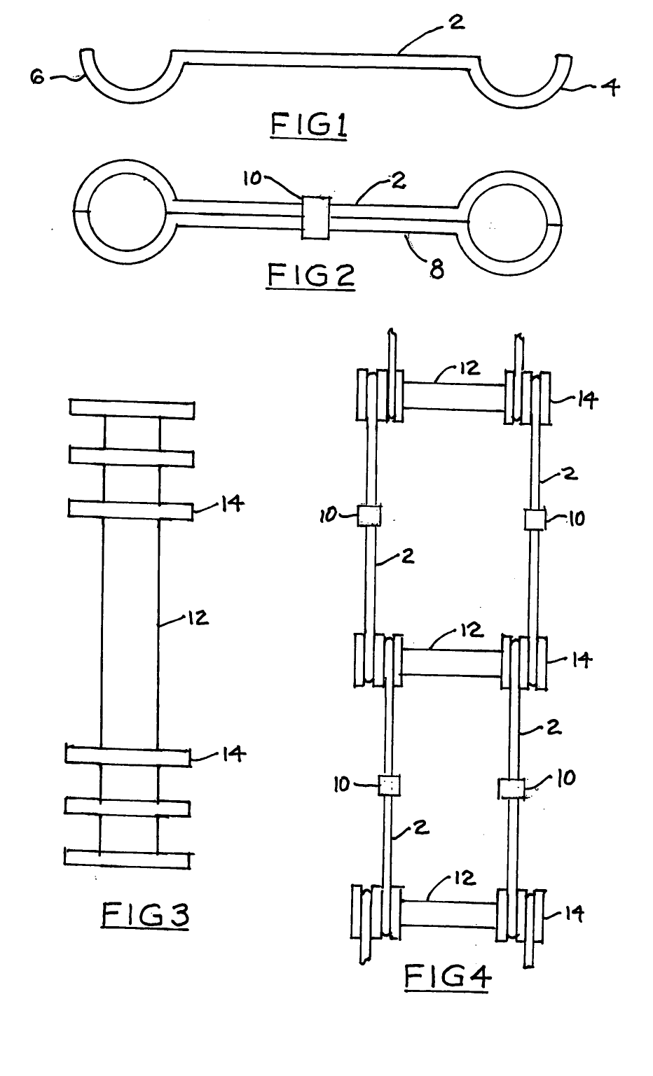

Referring to the drawings, FIG. 1 illustrates an elevation view of a side bar half-section. As seen in FIG. 1, the side bar half-section has a linear base with matching circular half loops 4 and 6 located at each end.

FIG. 2 illustrates an elevation view of two side bar half-sections clamped together to form one complete side bar. As seen in FIG. 2, a first side bar half-section 2 is paired with a second side bar half-section 8 so that the two half loops of one half-section and the two half loops of the second half-section form respective circles. The assembled side bar half-sections 2 and 8 are held together with a clamp 10 which is pressed onto the two half-sections.

FIG. 3 illustrates an elevation view of a barrel. As seen in FIG. 3, the barrel 12 (which can be hollow) is in the form of a cylinder and has at each end a series of radially extending shoulders 14 which are spaced apart and pass around the circumference of the barrel 12.

FIG. 4 illustrates an elevation view of a portion of a chain assembled from transverse barrels and longitudinally extending pairs of clamped side bars. As seen in FIG. 4, one barrel 12 is linked with another barrel 12 by a pair of side bar half-sections 2, 8 held together with respective clamps 10. The respective facing half loops of the side bar half-sections encircle and rotatably fit within the recesses between the shoulders 14 of each barrel 12. Two or more clamps 10 can be used per pair of side bar half-sections.

### EXAMPLE

A prototype of the pinless conveyor chain link according to the invention was constructed with a plastic barrel and steel side bars. The pitch of the side bars was six inches. A tensile force was applied to the link assembly and the assembly did not break until 8600 lbs. of force had been applied. This high breakage force was extremely good, and unexpected because conventional plastic chains or plastic and metal chains commonly break at forces in the neighborhood of 3000 lbs.

The pinless conveyor chain or drive chain according to the invention has a number of important advantages:

(1) The parts are very simple and therefore inexpensive to manufacture.

(2) Chain assembly is simple and quick and can be done on site, thus enabling easy and compact shipping of the components.

(3) In the event of failure, the links are easily disassembled without the problems of grinding off riveted pins or removing frozen or rusted pin nuts and/or cotter pins.

(4) The design of the chain enables the use of metal for the side bars for strength, with the material varying in thickness to increase or decrease the required working load of the chain, and plastic for the barrels to reduce weight.

(5) The design does not have pin heads and cotter pins projecting out the side so it is narrower than conventional chains. The side bars can be made of flat steel stock, which provides a thinner profile than the side bars of plastic chain, which must necessarily be much thicker for strength (sometimes in a round or ribbed profile). The result is that the centre of the outer link is much closer to the centre of the barrel where the sprocket contacts it, thus significantly reducing the bending force exerted on the barrel.

The chain according to the invention can be modified in various ways, some of which are mentioned below:

(1) The design may be altered by manufacturing the side bar pieces such that they meet in a place offset to the center of pull by the sprocket.

(2) The clamps holding each pair of end pieces together may be placed other than midway between the barrel sections. For example, two clamps could be used.

(3) The side bar piece sections could be formed from somewhat flexible material with opposing shoulders in the middle, so that on assembly, the end pieces are forced over the opposing shoulders in order to provide further support to the clamps and offset the separation forces caused by chain pull.

(4) The barrels, whether made of stainless steel, carbon steel, or plastic material, can be replaced as sacrificial elements of the chain, with re-use of the side bars, thus contributing to reduced landfill costs and recycling.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

1. A chain link comprising:
(a) a barrel with side bar retaining members thereon;
(b) a pair of first side bar half-sections with barrel gripping members at each end;
(c) a pair of second side bar half-sections with barrel gripping members at each end; and
(d) a pair of retaining members which respectively hold the first and second side bar half-sections together when the barrel gripping members hold the barrel.

2. A link as claimed in claim 1 wherein the barrel is a cylinder.

3. A link as claimed in claim 2 wherein the cylinder has radially extending shoulders at each end of the cylinder.

4. A link as claimed in claim 3 wherein the barrel gripping members are in the form of semicircles.

5. A link as claimed in claim 4 wherein when the first and second side bar half-sections are placed together, the semicircles at each end form whole circles.

6. A link as claimed in claim 1 wherein the barrel is hollow.

7. A link as claimed in claim 1 wherein the barrel is solid.

8. A chain link comprising:
(a) a barrel with at least two shoulders on the outside circumference thereof;
(b) four side bar half-sections with a semicircle formed at each end, wherein each two side bar half-sections form a whole side bar which connects to the barrel by placing the semicircles of the side bar half-sections around the barrel within two shoulders of the barrel so that two semicircles form a circle which encircles the barrel;
(c) a removable clamp affixed to each pair of side bar half-sections to hold the two side bar half-sections together.

9. A link as claimed in claim 8 wherein free ends of two semicircles of a pair of side bar half-sections touch each other when the two semicircles encircle the barrel.

10. A link as claimed in claim 9 wherein the barrel has three spaced parallel shoulders at one end of the barrel and three spaced parallel shoulders at the other end of the barrel.

11. A link as claimed in claim 8 wherein the barrel is solid.

12. A link as claimed in claim 8 wherein the barrel is hollow.

13. A link as claimed in claim 1 wherein the side bar half-sections are formed of metal.

14. A link as claimed in claim 1 wherein the barrel is formed of plastic.

15. A link as claimed in claim 1 wherein the barrel is formed of metal and plastic.

16. A link as claimed in claim 8 including two removable clamps for each pair of side bar half-sections.
